(19) United States
(12) Patent Application Publication
(10) Pub. No.: US 2012/0096025 A1
(43) Pub. Date: Apr. 19, 2012

(54) Method, Apparatus and System for Realizing Multi-person Conversation

(75) Inventors: Jingjing Li, Shenzhen City (CN); Shiyong Zhao, Shenzhen City (CN); Jian Zhai, Shenzhen City (CN); Hui Xiao, Shenzhen City (CN)

(73) Assignee: TENCENT TECHNOLOGY (SHENZHEN) COMPANY LIMITED, Shenzhen (CN)

(21) Appl. No.: 13/332,339

(22) Filed: Dec. 20, 2011

Related U.S. Application Data
(63) Continuation of application No. PCT/CN2010/074614, filed on Jun. 28, 2010.

(30) Foreign Application Priority Data
Jul. 3, 2009 (CN) 200910088154.X

(51) Int. Cl. G06F 17/30; G06F 15/16

(52) U.S. Cl. 707/769; 707/E17.014

(57) ABSTRACT

A method, apparatus and system for realizing multi-person conversation are disclosed. The method includes: a multi-person conversation window includes a searching window, and a client end receives a searching command and searching information through the conversation window in a multi-person conversation process. The searching information is passed to a server by the client end when the client end receives the searching command. The searching result information matched by the server based on the searching information and sent by the server is received by the client end. The received searching result information is displayed on the searching window of the conversation window by the client end. The method enables the combination between multi-person conversation and webpage searching, so that the switching between a searching webpage and a conversation window can be avoided, and the conversation among multiple persons can be facilitated.

The present application is a continuation of International Application No. PCT/CN2010/074614, filed on Jun. 28, 2010. The present application claims priority to Chinese Patent Application No. 200910088154.X, filed on Jul. 3, 2009, titled “METHOD, APPARATUS AND SYSTEM FOR REALIZING MULTI-PERSON CONVERSATION”, the entirety of which is hereby incorporated by reference.

### FIELD OF THE INVENTION

The present invention refers to webpage searching technology, and more particularly, to a technique for realizing webpage searching in a multi-person conversation process.

### BACKGROUND OF THE INVENTION

In a multi-person (the number of persons is equal or greater than two) conversation process through a conversation window, if it is needed to search for some information, another new browser or a new browsing webpage in the current browser is opened to enter into a search site webpage, and information needed to be searched is entered into a search bar of the search site webpage. Thereafter, a search button is triggered to obtain a searching result webpage, in order to realize information searching.

If some searched content need to be provided to other conversation participants, it is needed to copy information in the searching result webpage, then to switch to the conversation window and paste the copied content in the conversation window, and then to send the copied content to the other conversation participants.

In the process for implementing the present invention, inventors found that the aforementioned existing technology has at least the following problems.

When a search is executed in a multi-person conversation process, a search browser and the like is needed for executing the search. Therefore, it is needed to switch between a searching webpage and a conversation window. Thus, a timely search cannot be executed when maintaining the conversation process. Further, the implementation process of providing the searched information to other conversation participants is complicated.

### SUMMARY OF THE INVENTION

Embodiments of the present invention provide a method, apparatus and system for realizing multi-person conversation which combines multi-person conversation with webpage searching, so that the switching between a searching webpage and a conversation window can be avoided and the conversation among multiple persons can be facilitated.

A method for realizing multi-person conversation provided in an embodiment of the present invention uses a conversation window including a searching window. The method includes:

receiving a searching command and searching information by a client end through the conversation window in a multi-person conversation process;

sending the searching information to a server by the client end when the client end receives the searching command;

receiving searching result information by the client end, the searching result information being matched by the server based on the searching information and sent by the server; and

displaying the searching result information on the searching window of the conversation window by the client end.

An apparatus for realizing multi-person conversation provided in an embodiment of the present invention includes:

a first receiving module configured to receive a searching command and searching information through a conversation window in a multi-person conversation process, and to receive searching result information which is sent by a server and is matched by the server based on the searching information;

a first sending module configured to send the searching information to the server after the first receiving module receives the searching command; and

a display module configured to display the searching result information received by the first receiving module on a searching window of the conversation window.

A system for realizing multi-person conversation provided in an embodiment of the present invention includes:

a client end configured to receive a searching command and searching information through a conversation window, and to send the searching information to a server after the client end receives the searching command, to receive searching result information sent by the server and to display the searching result information on a searching window of the conversation window; and

the server configured to obtain the searching result information via matching based on the searching information after receiving the searching information, and to send the searching result information to the client end.

It can be seen from the aforementioned description of the technical solution, multi-person conversation is combined with webpage searching by: setting a searching window in a conversation window, and receiving the searching command through the conversation window in a multi-person conversation process, and using the searching window to realize search. This can avoid the switching between the searching webpage and the conversation window when there is a search requirement during the multi-person conversation process. In this way, the technical solutions provided by the present invention facilitate the conversation among multiple persons.

### BRIEF DESCRIPTION OF DRAWINGS

In order to more clearly illustrate embodiments of the present invention or the technical solutions in the existing technology, the figures need to be used in the description of the embodiments or the existing technology will be briefly described in the following. Obviously, the figures in the following description are only some embodiments of the present invention. It is easy for those skilled in the art to obtain other figures based on the following figures without creative work.

FIG. 1 is a flow chart of a method for realizing multi-person conversation of a first embodiment of the present invention.

FIG. 2 is a flow chart of a method for realizing multi-person conversation of a second embodiment of the present invention.

FIG. 3A is a flow chart of a method for realizing multi-person conversation of a third embodiment of the present invention.

FIG. 3B is a schematic diagram of a conversation window of the third embodiment of the present invention.

FIG. 4 is a schematic diagram of an apparatus for realizing multi-person conversation of a fourth embodiment of the present invention.

FIG. 5 is a schematic diagram of a system for realizing multi-person conversation of a fifth embodiment of the present invention.

### DETAILED DESCRIPTION OF THE INVENTION

First embodiment: a method for realizing multi-person conversation. In the method of this embodiment, a searching window is set in a conversation window. At this time, the conversation window includes a conversation region and the searching window. Here, the searching window can also be called searching region. The searching window includes a search bar to which information needed to be searched is entered.

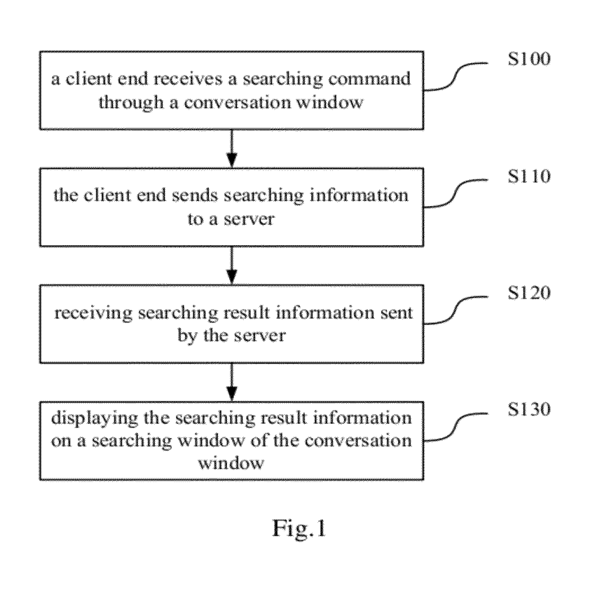

The schematic flow chart of the method provided in the first embodiment of the present invention is shown in FIG. 1. The method includes the following steps.

S100: a client end receives a searching command and searching information through a conversation window in a multi-person conversation process.

Here, the client end can be a conversation client end. For example, the client end can be a client end corresponding to an instant messaging tool, and the like.

There are several ways in which the client end receives the searching command through the conversation window. For example, when a user clicks on a search button in the conversation window, the client end receives the searching command. For another example, when the user selects a search option in a menu of the conversation window, the client end receives the searching command.

The specific implementation way in which the client end receives the searching command through the conversation window is not limited in embodiments of the present invention.

The searching information received by the client end can be information which is manually input into the search bar by the user, that is, the user directly inputs the information needed to be search into the search bar through a keyboard, an external input device or in a handwriting touch input way, or the like.

On the other hand, the searching information received by the client end can also be conversation information selected from a conversation record in the conversation window. In the multi-person conversation process, the conversation window can show the conversation record of all the conversation participants. The user can select the conversation information from the conversation record. When the client end receives the searching command, the client end adds the currently selected conversation information into the search bar in the searching window. That is, when the user selects conversation information from the conversation record and triggers a search (i.e., clicking on the search button), the currently selected conversation information atomically appears in the search bar of the searching window, so that the selected conversation information becomes searching information in the search bar. The searching information in this embodiment can also be called search keywords.

The client end can obtain the searching information after receiving the searching command. The client end can also obtain the searching information before receiving the searching command. For example, during the process of inputting the searching information into the search bar by the user, the client end can real-time obtain the searching information from the search bar. In this way, the client end has already obtained the searching information before the client end receives the searching command. When the searching command is received, the client end can directly execute a search. For another example, during the process of inputting the searching information into the search bar by the user, the client end does not obtain the searching information from the search bar. Instead, the client end obtains the searching information from the search bar after receiving the searching command, and executes a search. In still another example, in an application scene of selecting conversation information by the user, the client end obtains the conversation information currently selected by the user after the client end receives the searching command. In such an application scene, when the client end receives the searching command, there is no searching information in the search bar. Thus, the client end will obtain the searching information directly based on the selection of the user from the conversation information. The specific implementation way in which the client end sends the searching information to the server when the client end receives the searching command is not limited in embodiments of the present invention.

S110: the client end sends the searching information to a server after the client end receives the searching command.

Here, the server can be a keyword processing server for webpage search. The searching information sent to the server by the client end can be information manually input into the search bar by the user, and can also be the selected conversation information from the conversation record in the conversation window.

S120: the client end receives searching result information sent by the server.

The searching result information sent by the server to the client end can be searching result information which matches the searching information and which is obtained by the server through a variety of matching modes. For example, the server finds information matching the searching information in its database utilizing any one or more of an accurate matching mode, an include matching mode, a pattern matching mode and an interface query mode. The found out matching information is the searching result information.

S130: the client end displays the received searching result information on the searching window of the conversation window.

The client end can display the searching result information using a variety of ways. For example, the client end can display the searching result information on the searching window of the conversation window in a descending order based on precise degree of matching. For another example, the client end can also display the searching result information utilizing a richbox-based display mode. The display mode in which the searching result information is displayed on the searching window of the conversation window is not limited in embodiments of the present invention.

Optionally, if the user wants to provide the searching result information to other conversation participants, the user can trigger search shared operation, for example, the user can click on a search shared button and the like. The user triggering the search shared operation can make the client end receive a search shared command. After the client end receives the search shared command, the client end will share the searching result information which is currently displayed in the searching window of the conversation window with other conversation participants, so that the searching result information can also be displayed in searching windows set in conversation windows of the other conversation participants.

It should be noted, any conversation participant can independently execute search operation in a searching window of his/her own conversation window. For example, a new search process can be executed in the searching window. For another example, some search link or the like can be opened. The search processing operation executed independently by each conversation participant in the searching window of his/her own conversation window has nothing to do with other conversation participants, that is, the searching result of the search processing operation is not displayed in the searching windows of the other conversation participants, unless the user triggers the search shared operation (for example, clicking on a shared button). When the user clicks on the shared button, the client end of the conversation participant receives the search shared command, and the client end will provide the current searching result information which is displayed in the searching window of the conversation window to the other conversation participants. When the aforementioned other conversation participants include multiple persons, the current searching result information in the searching window can be selectively provided to all or parts of the other conversation participants.

Optionally, when the client end receives the search shared command, the client end can add share information into the conversation record in the conversation window. The share information is used to record sharing operation. Specifically, the share information can be what information is shared, with whom and when.

Second embodiment: a method for realizing multi-person conversation.

In the method provided in this embodiment, a searching window is set in a conversation window. At this time, the conversation window includes a conversation region and the searching window. Here, the searching window can also be called searching region. The searching window includes a search bar to which information need to be searched is input.

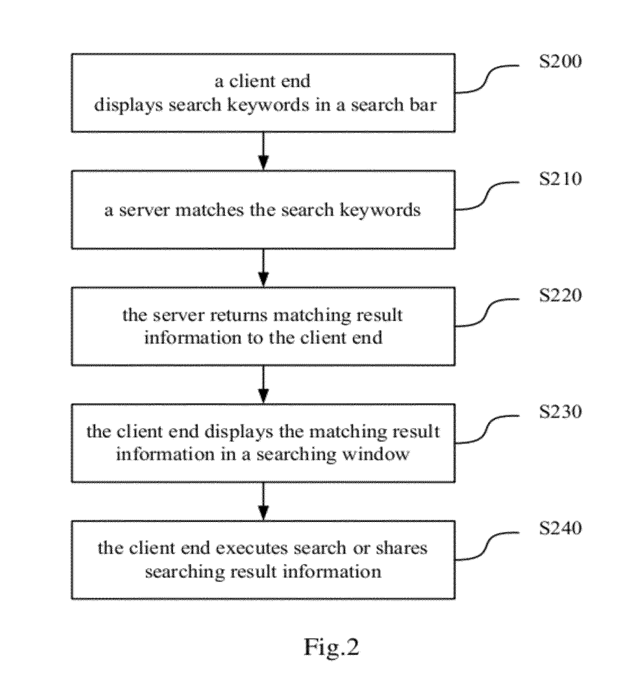

The schematic flow chart of the method provided in the second embodiment of the present invention is shown in FIG. 2. The method includes the following steps.

S200: a user has a search requirement during the process the user is in conversation with other conversation participants, and the user manually selects search keywords from a conversation record in the conversation window, and clicks on a search button to trigger a search behavior.

The search keywords are displayed in the search bar of the searching window by the client end. The search keywords can be sent to a server by the client end.

S210: the server receives the search keywords, and a search engine of the server matches the search keywords with keywords in a database.

The matching mode can be any one or more of an accurate matching mode (the input search keywords 100% match with the keywords in the database), an include matching mode (it is deemed as matching when the keywords in the database include the input search keywords), a pattern matching mode (according to a regular rule, it is deemed as matching when the input search keywords comply with a given pattern) and an interface query mode (find the input search keywords through a specific interface, and it is deemed as matching when the target is hit).

S220: the server returns matching result information (that is, searching result information) searched by the search engine to the client end.

S230: the client end receives the matching result information sent by the server, and displays the matching result information in the searching window of the conversation window.

S240: after the user reads the matching result information in the searching window, the user can continue the search behavior based on his/her search requirement, and can also determine to share the searching result information with other conversation participants.

If the user continues the search behavior, the user continues executing corresponding searching process based on the user's search requirement. If the user determines to share the searching result information with other conversation participants, the client end will provide the searching result information which is currently displayed in the searching window to all or parts of the other conversation participants according to the received search shared command. When the client end provides the searching result information which is currently displayed in the searching window to the other conversation participants, conversation windows of the other conversation participants can also display the searching result information. Similarly, the other conversation participants can also continue their search behavior in their conversation windows, and the search behavior will not affect the content displayed in the searching windows of the other conversation participants.

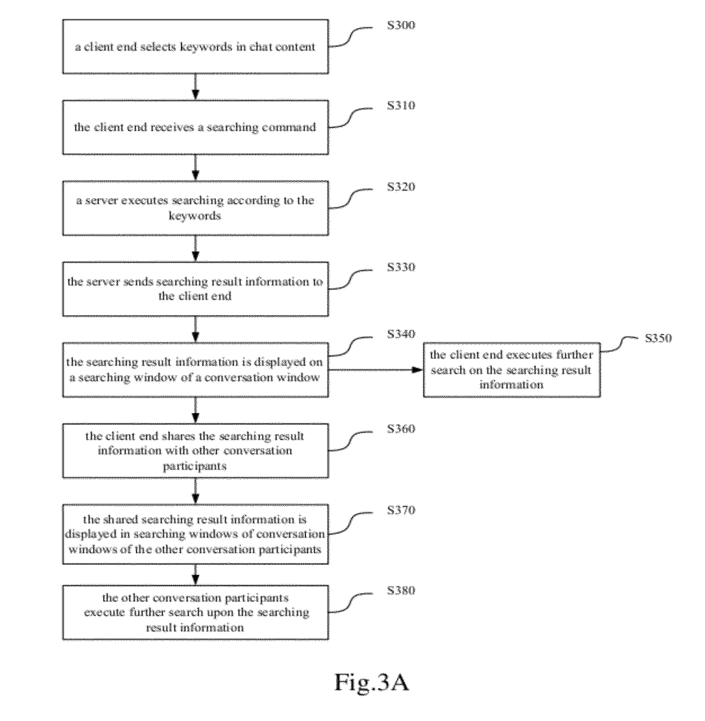

Third embodiment: one specific application of the multi-person conversation realizing method is described in the following in combination with FIG. 3A and FIG. 3B. FIG. 3A is a flow chart of the third embodiment. FIG. 3B is a schematic view of a conversation window.

In FIG. 3A, S300: a client end selects keywords from the chat content in a conversation window. The chat content is a conversation record in the conversation window. The selected keywords are search keywords. The search keywords can be, for example, Desires of the Heart shown in FIG. 3B.

S310: the client end receives a searching command, for example, the client end detects that a search button is triggered. The search button can be set in a toolbar. The search button can be, for example, “SOSO (Search)” button on the right of a search bar as shown in FIG. 3B. The client end sends to the server the search keywords, that is, Desires of the Heart.

S320: a search engine of the server executes searching according to the received Desires of the Heart.

Here, the server can utilize any one or more of an accurate matching mode, an include matching mode, a pattern matching mode and an interface query mode to execute the search. The found out matching information is the searching result information.

S330: the server sends the searching result information got by searching to the client end.

S340: the client end receives the searching result information sent by the server, and displays the searching result information on a searching window of its conversation window. The searching window can be, for example, the right window of FIG. 3B. That is, the searching window of FIG. 3B is at the right side of the conversation window.

If the user wants to continue executing search operation in the searching window, then S350 is performed. If the user wants to share the searching result information with other conversation participants, then S360 is performed.

S350: the client end can execute further search upon the searching result information, and can also execute other search operation carried out for new search keywords in the searching window.

The search operation executed by the client in this step will not affect searching windows of other conversation participants.

S360: after the client end detects that a shared button is triggered, the client end shares the searching result information which is currently displayed in the searching window with its chat objects, i.e., other conversation participants.

Additionally, sharing tips can be provided in the chat content of the conversation window of the client end, to show the searching result information shared at this moment.

S370: The searching result information is simultaneously displayed in the right side of the conversation window of a chat object.

If the chat object wants to continue executing search operation in the searching window, S380 is performed.

S380: the chat object executes further search on the searching result information in the searching window, and this further search does not affect other chat objects.

In each of the above embodiments, multi-person conversation is combined with webpage searching by setting a searching window in a conversation window, receiving a searching command through the conversation window in a multi-person conversation process, and using the searching window to realize search. This can avoid the switching between the searching webpage and the conversation window when there is a search requirement during the multi-person conversation process. By sharing the current searching result information with other conversation participants, the copy and paste operation between the searching webpage and the conversation window can be avoided. Additionally, each conversation participant can execute independent search operation in a searching window of his/her own conversation window, other conversation participants will not be affected by the result of the search operation of this conversation participant, and the unnecessary bother to the other conversation participants can be avoided. Therefore, each of the above embodiments facilitates the conversation among multiple persons.

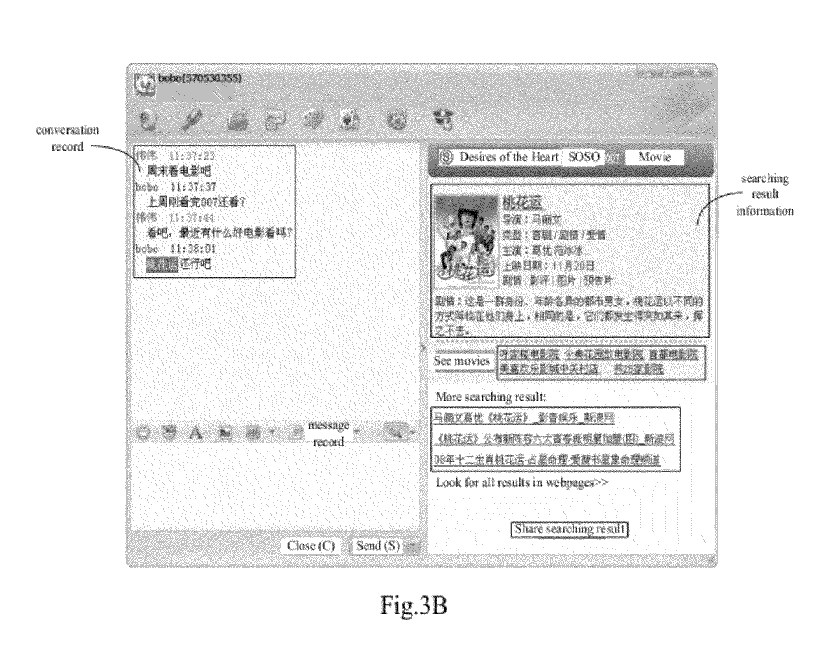

Fourth embodiment: apparatus for realizing multi-person conversation. The apparatus can be a client end, for example, a client end of an instant messaging tool and the like. The structure of the apparatus is shown in FIG. 4.

The apparatus shown in FIG. 4 includes: a first receiving module 400, a first sending module 410 and a display module 420. Optionally, the apparatus can further include a sharing module 430.

The first receiving module 400 is configured to receive a searching command and searching information through a conversation window in a multi-person conversation process, and to receive searching result information sent by a server. The searching result information is obtained by the server via performing matching on the received searching information. The searching result information sent by the server to the client end can be searching result information which matches the searching information and which is obtained by the server through a variety of matching modes. For example, the server finds information matching the searching information in its database utilizing any one or more of an accurate matching mode, an include matching mode, a pattern matching mode and an interface query mode. The found out matching information is the searching result information.

There are several ways in which the first receiving module 400 receives the searching command through the conversation window. For example, when a user clicks on a search button in the conversation window, the first receiving module 400 receives the searching command. For another example, when the user selects a search option in a menu of the conversation window, the first receiving module 400 receives the searching command. The specific implementation way in which the first receiving module 400 receives the searching command through the conversation window is not limited in embodiments of the present invention.

The first sending module 410 is configured to send the searching information to the server after the first receiving module 400 receives the searching command. The searching information is information within a search bar of a searching window set in the conversation window. The searching information can be information which is manually input into the search bar by the user, and can also be conversation information selected by the user from a conversation record in the conversation window. The searching information in this embodiment of the present invention can also be called search keywords.

The first receiving module 400 can obtain the searching information after receiving the searching command, and can also obtain the searching information before receiving the searching command. For example, during the process of inputting the searching information into the search bar by the user, the first receiving module 400 can real-time obtain the searching information from the search bar. In this way, the first sending module 410 can send the searching information currently obtained by the first receiving module 400 to the server after the first receiving module 400 receives the searching command. For another example, during the process of inputting the searching information into the search bar by the user, the first receiving module 400 does not obtain the searching information from the search bar. Instead, the first receiving module 400 obtains the searching information from the search bar after receiving the searching command. In still another example, in an application scene of selecting conversation information by the user, the first receiving module 400 obtains the currently selected conversation information by the user after the first receiving module 400 receives the searching command. The specific implementation way in which the first sending module 410 sends the searching information to the server when the first receiving module 400 receives the searching command is not limited in embodiments of the present invention.

The display module 420 is configured to display the searching result information received by the first receiving module 400 on the searching window of the conversation window. The display module 420 can display the searching result information using a variety of ways. For example, the display module 420 can display the searching result information on the searching window of the conversation window in a descending order based on precise degree of matching. For another example, the display module 420 can also display the searching result information utilizing a richbox-based display mode.

When the user selects conversation information from the conversation record in the conversation window and triggers a search operation and after the first receiving module 400 receives the searching command, the display module 420 can further add the conversation information selected from the conversation window into the search bar of the searching window. That is, when the user selects the conversation information from the conversation record and triggers a search (i.e., clicking on the search button), the currently selected conversation information atomically appears in the search bar of the searching window.

The first receiving module 400 can also receive a search shared command through the conversation window. Specifically, if the user wants to provide the searching result information to other conversation participants, the user can trigger search shared operation. For example, the user can click on a search shared button and the like. After the user triggers the search shared operation, the first receiving module 400 can receive the search shared command through the conversation window.

After the first receiving module 400 receives the search shared command, the sharing module 430 will share the current searching result information which is displayed in the searching window with other conversation participants, so that the current searching result information can be displayed in searching windows in conversation windows of the other conversation participants. When the user does not trigger the search shared operation (for example, clicking on the search shared button), the sharing module 430 will not provide the current searching result information which is displayed in the searching window of the conversation window to the other conversation participants. Additionally, when the aforementioned other conversation participants include multiple persons, the current searching result information in the searching window can be selectively provided to all or parts of the other conversation participants by the sharing module 430.

Optionally, when the first receiving module 400 receives the search shared command, the sharing module 430 can add share information to the conversation record in the conversation window. The share information is used to record sharing operation. The share information can be what information is shared, with whom and when.

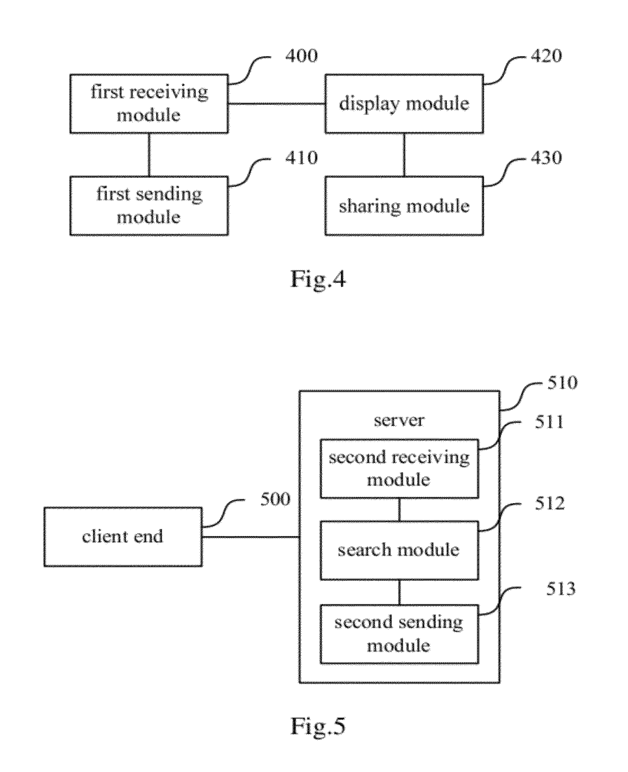

The fifth embodiment: a system for realizing multi-person conversation. The structure of the system is shown in FIG. 5.

The system shown in FIG. 5 includes: a client end 500 and a server 510.

The structure of the client end 500 can be referred to the description of the aforementioned fourth embodiment, and will not be repeated in this embodiment. The server 510 can include a second receiving module 511, a search module 512 and a second sending module 513.

The client end 500 is used to receive a searching command and searching information through a conversation window. The client end 500 sends the searching information in a searching window of the conversation window to the server after the client end 500 receives the searching command. Here, the searching information is information in a search bar. The client end 500 receives searching result information sent by the server 510, and displays the searching result information on the searching window of the conversation window.

The server 510 is configured to obtain the searching result information via matching based on the searching information after receiving the searching information sent by the client end 500, and to send the searching result information to the client end 500. Here, the server can be a keyword processing server for webpage search.

The second receiving module 511 is configured to receive the searching information sent by the client end 500.

The search module 512 is configured to find out the searching result information which matches the searching information received by the search module 512 by use of any one or more of an accurate matching mode, an include matching mode, a pattern matching mode and an interface query mode.

The second sending module 513 is configured to send the searching result information to the client end 500.

In view of the above description of the embodiments, those skilled in the art can clearly understand that the present invention may be realized via software and necessary common hardware platform, and may also be realized via hardware. However, in many situations, the former is a better implementation way. Based on this understanding, the nature of the technical solution of the present invention or the contribution to the existing technology can be reflected in the form of software products. The computer software products are stored in a storage medium, such as: ROM (Read-Only Memory)/RAM (Random Access Memory), disk, CD-ROM and the like. The storage media includes instructions for making computer equipment (which may be a personal computer, a server, or network equipment, etc.) performing the method of each embodiment of the present invention.

The above disclosure is only a few specific embodiments of the present invention. However, the present invention is not limited to the above disclosure. Any modification, which can be easily conceived by those skilled in the art, falls into the protection scope of the present invention.

1. A method for realizing multi-person conversation, comprising:
receiving a searching command and searching information by a client end through a conversation window in a multi-person conversation process, wherein a searching window is set in the conversation window;
sending the searching information to a server by the client end when the client end receives the searching command;
receiving searching result information by the client end, the searching result information being matched by the server based on the searching information and sent by the server; and
displaying the searching result information on the searching window of the conversation window by the client end.

2. The method of claim 1, wherein the searching window further comprises a search bar; and
wherein sending the searching information to the server by the client end comprises:
with the client end, adding conversation information selected from conversation record of conversation participants displayed in the conversation window into the search bar in the searching window as the searching information, and sending the searching information to the server.

3. The method of claim 1, wherein the searching result information sent by the server comprises:
searching result information which matches the searching information and which is obtained by the server utilizing at least one mode including an accurate matching mode, an include matching mode, a pattern matching mode and an interface query mode.

4. The method of claim 1, further comprising:
sharing current searching result information which is displayed in the searching window with other conversation participants by the client end after the client end receives a search shared command, so that the current searching result information is displayed in searching windows in conversation windows of other conversation participants.

5. The method of claim 1, further comprising:
executing search operation by the client end of each of the conversation participants in the client end's searching window, and providing searching result information corresponding to the search operation by the client end to corresponding user of the client end itself when the client end does not receive the search shared command.

6. An apparatus for realizing multi-person conversation, comprising:
a first receiving module, configured to receive a searching command and searching information through a conversation window in a multi-person conversation process, and to receive searching result information which is sent by a server and is matched by the server based on the searching information;
a first sending module, configured to send the searching information to the server after the first receiving module receives the searching command; and
a display module, configured to display the searching result information received by the first receiving module on a searching window of the conversation window.

7. The apparatus of claim 6, wherein
the display module is further configured to add conversation information selected from conversation record of conversation participants displayed in the conversation window into a search bar in the searching window after the first receiving module receives the searching command.

8. The apparatus of claim 6, wherein the first receiving module is further configured to receive a search shared command; and
the apparatus further comprises:
a sharing module, configured to share current searching result information which is displayed in the searching window with other conversation participants, so that the current searching result information is displayed in searching windows in conversation windows of the other conversation participants after the first receiving module receives the search shared command.

9. A system for realizing multi-person conversation, comprising:
a client end configured to receive a searching command and searching information through a conversation window, and to send the searching information to a server after the client end receives the searching command, to receive searching result information sent by the server and to display the searching result information on a searching window of the conversation window; and
the server configured to obtain the searching result information via matching based on the searching information after receiving the searching information, and to send the searching result information to the client end.

10. The system of claim 9, wherein the server comprises:
a second receiving module configured to receive the searching information sent by the client end;
a search module configured to find out the searching result information which matches the searching information by use of at least one mode including an accurate matching mode, an include matching mode, a pattern matching mode and an interface query mode; and
a second sending module configured to send the searching result information to the client end.
